(19) United States
(12) Patent Application Publication
(10) Pub. No.: US 2018/0369824 A1
(43) Pub. Date: Dec. 27, 2018

(54) COMMINUTING MACHINE WITH RADAR-ASSISTED WEAR MEASUREMENT FUNCTION

(71) Applicants: Thyssenkrupp Industrial Solutions AG, Essen (DE); INDURAD GMBH, Aachen (DE)

(72) Inventors: David Sudmann, Münster (DE); Timo Bischof, Münster (DE); Reik Winkel, Aachen (DE); Matthias Rabel, Ulm (DE)

(73) Assignees: Thyssenkrupp Industrial Solutions AG, Essen (DE); indurad GmbH, Aachen (DE)

(21) Appl. No.: 16/064,548

(22) PCT Filed: Dec. 15, 2016
(86) PCT No.: PCT/DE2016/100589

§ 371 Date: Jun. 21, 2018

(30) Foreign Application Priority Data
Dec. 21, 2015 (DE) 10 2015 122 372.4

(51) Int. Cl. B02C 2/04; B02C 2/00; G01S 13/88

(52) U.S. Cl. CPC B02C 2/047; B02C 2210/01; G01S 13/88; B02C 2/005

(57) ABSTRACT

The invention relates to a comminuting machine such as a crusher, a mill, or the like, wherein the material to be comminuted is guided through a gap which is formed between at least one wear layer attached to a component of the comminuting machine and a counter surface and the extension of which varies as the wear of the at least one wear layer progresses. The invention is characterized in that in order to determine the wear occurring on the wear layer and/or in order to determine the effective extension of the gap between the wear layer and the counter surface, a radar antenna is provided which is oriented towards the corresponding counter surface. The radar antenna comprises an antenna region and a wear part which is paired at least with the wear layer region provided for a permissible wear and which shortens as the wear layer wears down.

### CROSS-REFERENCE TO RELATED APPLICATION

This application is the U.S. national stage of PCT/DE2016/100589, filed Dec. 15, 2016, which claims priority of German patent application no. 10 2015 122 372.4, filed Dec. 21, 2015of which is hereby incorporated by reference in its entirety.

### FIELD OF INVENTION

The invention relates to a comminuting machine such as a crusher, a mill, or the like, in which the material to be comminuted is guided through a gap which is formed between at least one wear layer applied to a component of the comminuting machine and a counter surface and the extension of which varies as the wear of the at least one wear layer progresses. Comminuting machines of this kind are in particular provided for comminuting raw material, so-called minerals, and here in particular for use in mining or in the cement industry.

### BACKGROUND OF THE INVENTION

If a rotary crusher can count as an application example for the invention, such a rotary crusher is described in DE 198 53 900 A1. The rotary crusher comprises an outer crusher housing that is lined at the inner side with crusher jaws (crusher jacket) comprising a wear layer. A shaft carrying a crusher head is arranged in the comminution space of the rotary crusher surrounded by the crusher jaws and is set into a wobble movement by a drive, with a gap that defines the final grain size of the material to be comminuted by the rotary crusher being formed at the lower end of the conical crusher head between a wear layer attached to its outer side and the wear layer at the housing side and forming the crusher jaws. In the course of this comminution, a continuous wear occurs at the wear layers of the crusher jaws and of the crusher head and makes a change of the respective wear layer necessary at time intervals, with a change in the dimension of the crusher gap additionally also occurring during the operating life of the wear layers in the operation of the rotary crusher.

In the aforesaid DE 198 53 900 A1, a method of setting the crusher gap is provided for such a rotary crusher, for the carrying out of which a sensor is introduced into the interior of the housing which has a borescope and is configured as an endoscope connected to a television camera and by means of which the region of the crusher gap is detected by means of the television camera and is made visible on a screen. The respective wear that has occurred can be determined based on a comparison of the respective measured values for the crusher gap using the values determined in the new state of the rotary crusher. The disadvantage is associated with the known rotary crusher and with the method used with it that the measurement unit comprising the borescope, endoscope, television camera, and screen is complex and/or expensive and is difficult to handle in use. It is in particular complex in this respect to travel the sensor into the interior of the housing in each case for carrying out a measurement and to position it there in each case such that repeatable measurements can be carried out with comparable values. At the same time, there is the further disadvantage that the material flow of the material to be comminuted has to be interrupted and the crusher has to be completely emptied. Corresponding setup times for the carrying out of each measurement are thus unavoidable.

Furthermore, in U.S. Pat. No. 3,944,146 A the use of ultrasound technology in a rotary crusher is known for monitoring the crusher gap and also for determining the wear occurring at the wear layer at the inner side. The measurement arrangement comprises two ultrasound heads of which one is arranged in the region of the crusher gap in the crusher housing outside the wear layer attached thereto and the other is arranged in the region of the lower foot of the crusher housing, with a reflection surface arranged at the piston of a hydraulic cylinder arrangement for adjusting the crusher head in the crusher housing being associated with the latter ultrasound head. Both ultrasound heads are connected to an ultrasound measurement unit and to an oscilloscope for representing the signal peaks. The ultrasound head arranged in the region of the crusher gap serves the direct determination of the respective thickness of the wear layer to the extent that the signal transmitted by the ultrasound head is reflected at the outer surface of the wear layer and the transit time is put into relation with the transit time applicable to the new state of the wear layer. To the extent that the sound waves emanating from this ultrasound measurement head are incident onto the opposite surface of the crusher head after passing through the wear layer, the extent of the crusher gap can be derived therefrom. Since this crusher gap determination is not possible during the operation of the rotary crusher due to the material running through the crusher gap, the inclusion of the second ultrasound measurement arrangement arranged at the foot of the crusher housing is provided in accordance with U.S. Pat. No. 3,944,146 A for a continuous crusher gap monitoring, with the extent of the crusher gap being mathematically determined during the operation of the rotary crusher and thereby being monitored on the basis of the results of both ultrasound measurement apparatus. The disadvantage is substantially associated with the know rotary crusher that the use of the ultrasound measurement technique is problematic in comminution machines, and in particular with crushers, because the ultrasound is disturbed by the operating sounds and comminution sounds occurring during the crushing if the frequencies used are overlaid with the noise caused by the sounds.

A comminuting machine having a measurement arrangement is known from WO 2014/187824 A1 that is based on the use of RFID sensors that can communicate wirelessly with a corresponding device. The RFID sensors are arranged at the active grinding elements and the RFID tags are successively destroyed on a progressing wear of the grinding elements so that a corresponding communication with the destroyed RFID tags is no longer possible. It can thus be recognized by a corresponding computer numerical reading how far a wear of the active grinding elements has progressed, with the grinding elements being configured as grinding wheels that wear from the outside and whose diameter reduces. If a plurality of RFID tags are arranged at the grinding wheels, starting from the outermost diameter, and if the outer RFID tags are destroyed by abrasive wear, how far the wear of the grinding wheels has progressed can be recognized by the sensors.

Such a use of RFID tags can, however, not be implemented with a crusher for opencast mining since the crusher plates of a crusher do not provide any possibility of taking up RFID tags so that they could also satisfy their function without wear. Due to the strong mechanical effect on the crusher plates, a long-term function of the RFID tags cannot be ensured, even though an abrasive wear of the active crushing surface of the crusher plates has not yet progressed up to the destruction of the RFID tags. Consequently, the object is set of developing a wear measurement for a crusher that can be used in opencast mining and with which hard raw materials in large parts can be comminuted and of in particular making possible a wear measurement during the operation of the crusher.

### SUMMARY OF THE INVENTION

It is therefore the underlying object of the invention to equip a comminution machine of the initially named kind such that an exact wear and gap determination can be performed by means of a more simply set up measurement arrangement without substantial setup times and to provide an evaluation method for determining the wear that has occurred and the respective gap present.

These objects are achieved, including advantageous embodiments and further developments of the invention, from the content of the claims that follow this description.

The basic idea of the invention provides that a radar antenna is arranged for determining the wear that occurs at the wear layer and/or for determining the respective current extent of the gap between the wear layer and the counter surface, with the radar antenna comprising an antenna region and a wear part at least associated with the region of the wear layer provided for a permitted wear and respectively reducing with the wear of the wear layer.

The invention thus enables the use of radar technology in wear determination for which robust, precise, and powerful measurement units are available. The special feature of the invention comprises the use of a radar antenna which is embedded at a fixed position in the wear layer comprising the wear material and whose extent reduces as the wear of the wear layer progresses so that a direct determination of the residual thickness of the wear layer is possible at any time and in every operating state while making use of the reflection of radar beams (epsilon R value) occurring at each material change and the determination of the gap between the wear layer and the counter surface is possible via the determination of the spacing between the respective end of the radar antenna disposed in the outer wear surface of the wear layer and the oppositely disposed counter surface of the comminution machine. In addition, a wear occurring at the counter surface can also be determined on the basis of the measured values provided that a wear layer is applied to this counter surface. The radar antenna here comprises an antenna region having a configuration known per se and a wear part placed thereon whose length is designed as at least as large as the extent or thickness of that section of the wear layer that is provided in a permitted manner for a wear before a required change of the wear layer. This means that the wear part of the radar antenna in accordance with the invention can also have a greater length than the thickness of the permitted wear region of the wear layer, that is it can also extend over the total thickness of the wear layer applied to the corresponding component of the comminution machine. The term of a measurement lobe to be associated with a radar antenna is generally to be understood as the propagation range of the radar waves emanating from the radar antenna.

To this extent, the advantage is associated with the invention that no special setup times arise for the carrying out of the measurements since the individual components of the radar measurement technique are fixedly installed at the comminution machine. The invention thus makes possible in comparison with the ultrasound measurement technique known from U.S. Pat. No. 3,944,146 A considerably faster measurements that can be carried out during ongoing operation, with the probability that the measurement region is free of the material to be comminuted at the point in time of the measurement probably being higher. The use of the radar antenna furthermore allows a more focused measurement beam and a sharper propagation behavior in comparison with the use of ultrasound.

The invention can here not only be used for a rotary crusher proposed by way of example, but rather also for other crusher constructions such as inter alia jaw crushers or roller crushers and also for further comminution devices such as mills and the like to the extent that, with respect to the comminution machines, it is a question of the detection of the wear state of a housing liner or of the determination of the gap width of a gap present between the housing liner and a comminution tool.

To the extent that care has to be taken that reflections or losses of radar waves caused by the switching on of the additional wear part adjoining the antenna region and falsifying a measurement result are produced, provision is made in accordance with an embodiment of the invention that the wear part of the radar antenna has a conicity expanding slightly in the direction toward the counter surface in comparison with the conical design of the antenna region and is configured such that the antenna directivity is maintained on the passing of the radar waves through the wear part and higher modes than the fundamental modes are prevented. The wear part is here preferably formed from comparably wear-resistant material like the wear layer, but that has dielectric properties suitable for radar. A ceramic material having corresponding properties can be named as a preferred material here.

In accordance with embodiments of the invention, the antenna region of the radar antenna is configured as a horn antenna, with a horn antenna preferably being used that is filled with a material having suitable dielectric properties such as a suitable ceramic material. Such horn antennas are generally known in radar technology. The use of a filled horn antenna is additionally advantageous over an open horn antenna that is more widespread in radar technology, but would easily clog with crushed material of the most varied consistency on use in a comminution machine.

Provision can be made in detail that the individual components of the antenna region and the wear part are adhesively bonded, soldered, or cemented to one another.

Provision can alternatively be made that the individual components of the antenna region and the wear part are arranged movable with respect to one another. This embodiment optionally takes the circumstance into account that components of the radar antenna might heat up in the operation of the comminution machine, with different coefficients of expansion having to be taken into account. Specifically, for example, a mounting by a plain bearing of the components can be provided at intermediate webs or also an arrangement can be provided as part of a bonded system enabling layer slip and comprising different materials.

Provision is made in accordance with an embodiment of the invention that the radar antenna is accommodated in a protective pipe embedded in the wear layer and abrading with the removal of the wear layer.

Provision is made in accordance with an embodiment of the invention that the radar antenna is connected to a radar sensor by means of a wave guide connected thereto, with provision being able to be made that the radar sensor is arranged outside the comminution space of the comminution machine.

To the extent that comminution machines have thick-walled housings or that the corresponding radar antenna is only to be arranged in such a thick-walled region of a housing, provision can be made that a wave guide extension is arranged between a flange formed at the radar antenna and the radar sensor. In particular a hollow wave guide known from the prior art can be used as an additional wave guide extension.

To the extent that a transition of the radar waves between two different media is present between the wave guide extension and the antenna region, provision can be made for producing a correspondingly soft transition of the radar waves that a transition region is arranged comprising a transition material suitable for anti-reflection.

Provision is made in accordance with an embodiment of the invention that the radar antenna is completely embedded in the wear layer. Provision can, however, alternatively also be made that the association of the radar antenna with the wear layer is such that the radar antenna is arranged at a free end of the wear layer, directly adjacent thereto, that is, for example, at the lower end of the wear layer.

Finally, provision can be made in accordance with an embodiment of the invention that channel-like cut-outs are arranged in the wear layer and/or in a housing part for receiving the radar antenna and/or the wave guide extension such that the corresponding components of the comminution machine are prepared for the use of the radar antenna in accordance with the invention ex works on production. In particular a radar antenna embedded in the wear layer can optionally be integrated or embedded on the casting of the wear layer. It must also be considered there likewise to accommodate the radar sensor in a corresponding cut-out.

To the extent that the comminution machine configured in accordance with the above-explained features delivers corresponding measurement values for the transit time of radar waves fed into the radar antenna integrated into the setup of the comminution machine, provision is made for evaluating these measurement values with respect to the determination of the wear that occurred at the wear layer that the transit time difference of the radar waves fed into the radar antenna comprising the antenna region and the wear part between their entry into the antenna region and their exit from the wear part is determined in an evaluation unit and is put into relation with the length specified in the new state of the comminution machine of the antenna region remaining unchanged and the wear part subject to wear and that the wear of the wear layer that has respectively occurred up to the time of the measurement is determined.

In a further development of the invention, the respective extent (width) of the gap can be determined to the extent that additionally the transit time of the radar waves between their exit from the wear part of the radar antenna up to the incidence on the counter surface is determined and is defined as the measure for the extent of the gap present between the wear layer and the counter surface.

On the presence of the values for the wear that has occurred at the wear layer and for the extent of the gap, a wear that has occurred in the region of the counter surface, that is, for instance, at a wear layer formed at a crusher head, can also be determined in that the wear that has occurred at the wear layer up to the point in time of a measurement, including the extent of the gap current at the point in time of the measurement, is put into relation with the dimensions for the wear layer and the gap specified in the new state of the comminution machine and a wear that has occurred at the wear layer of the crusher head forming the counter surface is determined therefrom.

### BRIEF DESCRIPTION OF THE DRAWINGS

Embodiments of the invention are shown in the drawing and will be described in the following. There are shown:

FIG. 1 a comminution machine configured as a rotary crusher in a perspective representation;

FIG. 2 a detail of a housing region of the rotary crusher with a radar antenna integrated therein in an enlarged representation;

FIG. 3 the article of FIG. 2 in a modified embodiment; and

FIG. 4 the radar antenna in accordance with FIG. 2 or FIG. 3 in an enlarged single representation.

### DETAILED DESCRIPTION OF THE PREFERRED EMBODIMENTS

To the extent that the invention is explained in more detail in the following with reference to a comminution machine configured as a rotary crusher, FIG. 1 corresponds to the corresponding representation in said DE 198 53 900 A1. The rotary crusher 10 comprises a housing 11 whose inner side is lined with a wear layer 12 called crusher jaws. A crusher head 13 that forms a counter surface 35 to the wear layer 12, that rests on a lower housing part 14, and that is driven by a drive 15 is arranged in the inner space of the housing 11. The crusher head 13 is provided at its outer side with a wear layer 20 whose outer side forms the counter surface 35. To the extent that the wear layer 12 and crusher head 13 respectively configured with opposite conicity form a crusher gap at their narrowest point with the wear layer, this crusher gap is at the level of a flange region 16 that is formed by an upper flange part 17 to be attributed to an upper housing part and by a lower flange part 18 to be attributed to the lower housing part 14.

To the extent that FIG. 2 shows a detail in an enlarged representation, this detail relates to the plane of the flange region 16 and the upper flange part 17 and the lower flange part 18 can thus be recognized in FIG. 2. It can further be recognized that the wear layer 12 attached to the inner side of the housing 11 is applied to the hosing 11 with an interposition of a partial casting compound 21; the same applies to the attachment of the wear layer 20 to the crusher head 13. A gap 22 is defined as a crusher gap at the narrowest point between the wear layer 20 of the crusher head 13 and the wear layer 12 of the housing 11.

In the embodiment shown in FIG. 2, a radar antenna 23 whose setup still has to be described in the following is arranged directly below the wear layer 12, with a bore 24 through which the radar antenna 23 can be pushed forward up to and into the position shown being introduced in the lower flange part 18 and the adjoining part of the housing 11. Provision can be made for this purpose that channel-like cut-outs are already prepared in the wear layer and/or in the corresponding housing and serve the reception of the radar antenna and/or of a connection pipe. To the extent that the radar antenna 23 is connected to a wave guide, in particular to a hollow wave guide, not shown in further detail and known from radar technology, the wave guide runs through the bore 24 up to and outside the housing 11 and is here connected to a radar sensor attached to a suitable point and indicated by 36.

In the embodiment shown in FIG. 3, the corresponding bore 24 is configured for receiving or leading through the radar antenna 23 in the upper flange part 17, which means that the radar antenna 23 is now arranged within the wear layer 12 and is completely embedded therein. Due to the greater extent of the associated housing region or of the upper flange part 17, provision is made in this respect that an additional wave guide extension 31 is used between the end of the radar antenna 23 and the wave guide not shown in any more detail here, with one end, a front end, of said wave guide extension being coupled to the radar antenna 23 and with a wave guide connected to a radar sensor being connected to the rear end of said wave guide extension in a coupling not shown in any further detail.

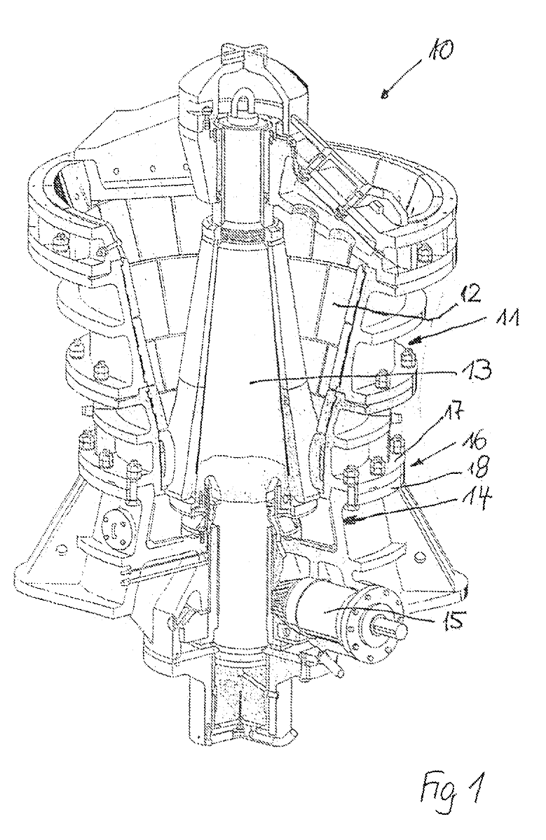

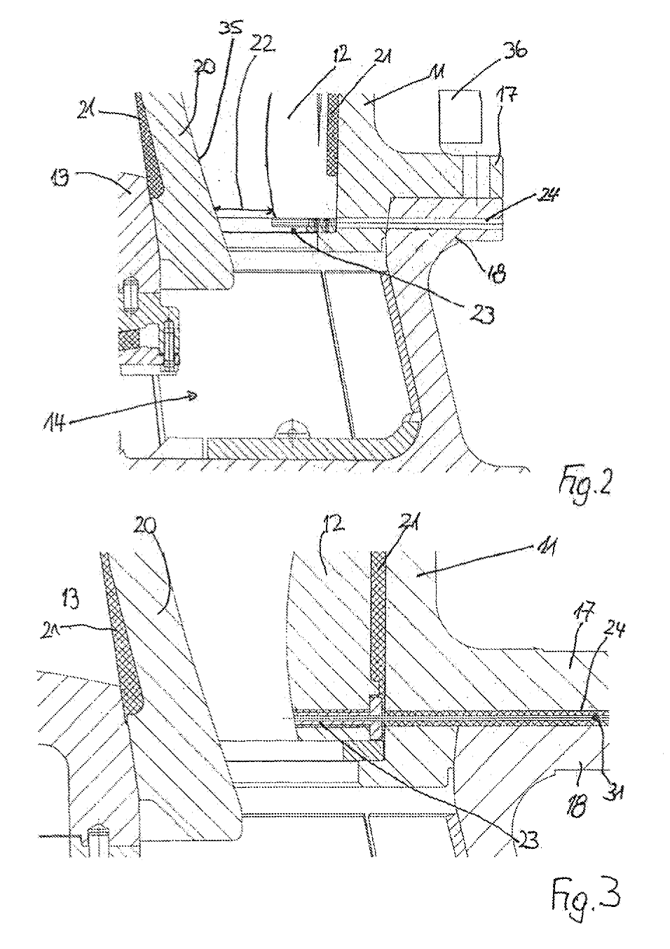

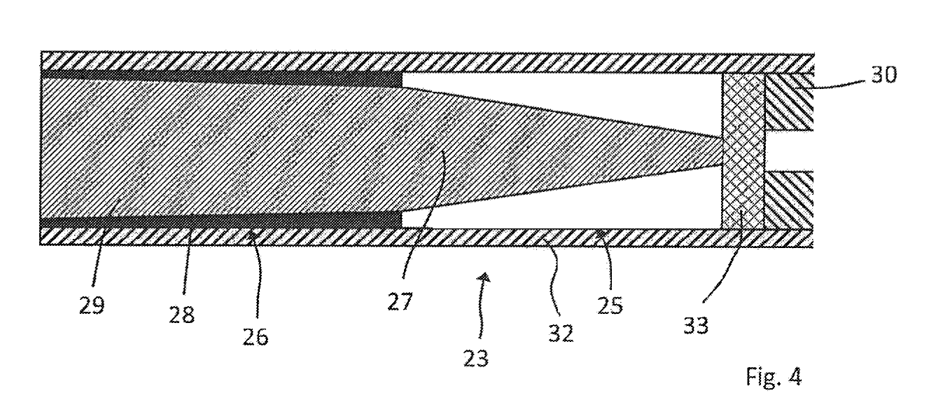

The setup of the radar antenna 23 is shown in detail in FIG. 4. The radar antenna 23 accordingly comprises an antenna region 25 forming the middle part of the antenna representation and a wear part 26 placed thereon in the representation at the left. A connector part 30 for the wave guide not shown in any further detail and having a round cross-section is arranged in the form of a hollow wave guide at the outer right end of the antenna part 25. A further transition region 33 is arranged between the antenna region 25 and the connector part 30. The antenna region 25 of the radar antenna 32 comprises a horn antenna which is known in radar technology, which is filled with a material having suitable dielectric properties, and which has a cross-section of the propagation region 27 for the radar waves expanding conically in the direction of the wear part 26. The wear part 26 only has a slight conicity at its wall 28 with respect to the conicity of the propagation region 27 of the antenna part 25 and is likewise filled with a wear-resistant material 29 having suitable dielectric properties. A suitable ceramic material can be used for this purpose. It should inter alia be ensured by this that the radar waves propagating from the antenna region 25 do not undergo any influence or reflections that falsify, damp, or delete the measurement result on the passage through the wear part 26. The transition region 33 includes an antireflection coating known in radar technology that provides a soft transition of the wave propagation from the connector part 30 into the antenna region 25. The setup of the radar antenna 23 is surrounded by an outer protective pipe 32 that can be designed as a metal pipe. This protective pipe, just like the wear part 26 of the radar antenna 23, is subject to a corresponding abrasion as the wear of the wear layer 12 progresses.

Depending on the setup or arrangement of the radar antenna 23, a transit time of the radar waves up to a reflection respectively occurring at a border layer that can be associated results for a radar sensor that is configured as a pulse radar, for example. The transmit time of the radar waves from the radar sensor via the air-filled hollow wave guide up to the entry into the antenna region 25 can equally be determined with a direct connection of the hollow wave guide to the antenna region 25 of the radar antenna 23 as its transit time up to the exit from the radar antenna at its front end surface of the wear part 26 into the medium of air. This transit time difference, that is directly measurable with a pulse radar, represents a measure for the length of the radar antenna 23 or of the wear part 26 remaining at this point in time and the respective present current material thickness of the wear layer 12 can be determined and the wear that has occurred in the meantime can be determined by a comparison with the length of the antenna region 25 and of the wear part 26 also remaining unchanged under wear, with said length being specified in the new state of the comminuting machine.

To the extent that the radar waves exiting the radar antenna 23 are incident on and reflected by the wear layer 20 located on the crusher head 13 as a counter surface after passing through the gap 22 present at the measurement point in time, the transmit time difference between the transit time of the radar waves up to the exit from the radar antenna 23 and the transit time up to the incidence onto the counter surface 35 on the crusher head 13 can likewise be determined and the extent of the gap 22, that is likewise desired as a monitoring parameter, can be directly derived from this transit time difference.

In addition, the invention thereby also enables a determination of the thickness of the wear layer 20 applied to the outer side of the crusher head 13 or of the wear that has occurred thereat beyond the wear measurement at the wear layer 12 preferably applied to the inner wall of a comminuting machine. Due to the knowledge of the wear that has occurred at the wear layer 12 and due to the extent of the gap 22 present at this measuring point in time, a back calculation is possible with respect to the wear that has occurred at the wear layer 21 to the extent that the dimensions applicable to the new state of the comminuting machine of the wear layer 12 and of the gap 22 are present and due to the changes that have occurred at the measurement point in time of the thickness of the wear layer 12 or of the extent of the gap 22, a calculation of the change that has occurred at the wear layer 20 of the crusher head 13 is likewise possible.

To the extent that a frequency-modulated radar is used, the correspondingly detectable frequency differences that permit a corresponding evaluation apply analogously to the transit time differences in pulse radar.

The features of the subject matter of these documents disclosed in the above description, in the claims, in the abstract, and in the drawing can be material, individually and also in any desired combination with one another, to the implementation of the invention in its various embodiments.

1-17. (canceled)

18. A comminuting machine/rotary crusher for comminuting raw materials/minerals, comprising:
a housing with an inner side lined with at least one wear layer;
a crusher head having a wear layer, a counter surface defined by an outer side of the wear layer of the crusher head;
a gap defined between the at least one wear layer of the housing and the counter surface of the crusher head, the comminuting machine operable to guide materials/minerals to be comminuted through the gap, the gap varying as the at least one wear layer of the housing erodes during operation of the comminuting machine;
a radar antenna for determining a wear occurring at the at least one wear layer of the housing due to erosion of the at least one wear layer of the housing during operation of the comminuting machine, the radar antenna operable to determine the gap between the at least one wear layer of the housing and the counter surface of the crusher head, the radar antenna being oriented toward the counter surface of the crusher head, wherein the radar antenna is associated with the at least one wear layer of the housing, the radar antenna comprising an antenna region and a wear part, the wear part of the radar antenna reducing due to erosion as the wear of the at least one wear layer of the housing increases.

19. The comminuting machine in accordance with claim 18, wherein the antenna region of the radar antenna has a conical design, the wear part of the radar antenna having a conicity that expands slightly in a direction toward the counter surface in comparison with the conical design of the antenna region to maintain directivity of the radar antenna and to prevent higher modes on the passage of the radar waves through the wear part.

20. The comminuting machine in accordance with claim 18, wherein the wear part of the radar antenna is formed from a wear-resistant material having dielectric properties suitable for the radar antenna.

21. The comminuting machine in accordance with claim 18, wherein the antenna region of the radar antenna is configured as a horn antenna.

22. The comminuting machine in accordance with claim 21, wherein the horn antenna is filled with a material having dielectric properties.

23. The comminuting machine in accordance with claim 18, wherein the antenna region and the wear part of the radar antenna each having individual components, and the individual components of the antenna region and/or of the wear part of the radar antenna are adhesively bonded, soldered, and/or cemented to one another.

24. The comminuting machine in accordance with claim 18, wherein the antenna region and the wear part of the radar antenna each have individual components, and the individual components of the antenna region and/or of the wear part of the radar antenna are movable with respect to one another.

25. The comminuting machine in accordance with claim 18, further comprising a protective pipe embedded in the at least one wear layer of the housing, wherein the radar antenna is accommodated in the protective pipe and the protective pipe abrades with the wear of the at least one wear layer of the housing due to erosion.

26. The comminuting machine in accordance with claim 18, further comprising a wave guide and a radar sensor, wherein the radar antenna is connected to the radar sensor by the wave guide.

27. The comminuting machine in accordance with claim 26, wherein the radar sensor is arranged outside a comminuting space of the comminuting machine.

28. The comminuting machine in accordance with claim 26, further comprising a wave guide extension interposed between a flange formed at the radar antenna and the radar sensor.

29. The comminuting machine in accordance with claim 26, wherein a transition region comprising a transition material and used for anti-reflection is arranged to provide a soft transition of the radar waves between two different materials from the wave guide to the antenna region of the radar antenna.

30. The comminuting machine in accordance with claim 18, wherein the radar antenna is completely embedded in the at least one wear layer of the housing.

31. The comminuting machine in accordance with claim 18, further comprising channel-like cut-outs arranged in the at least one wear layer of the housing and/or in a housing part for receiving the radar antenna.

32. The comminuting machine in accordance with claim 26, further comprising channel-like cut-outs arranged in the radar sensor.

33. The comminuting machine in accordance with claim 28, further comprising channel-like cut-outs arranged in the wave guide extension.

34. A method of operating a comminuting machine, comprising:
providing a comminuting machine of claim 18;
determining a transit time difference of the radar waves fed into the radar antenna between their entry into the antenna region and their exit from the wear part of the radar antenna in an evaluation unit;
putting the transit time difference into relation with a length of the antenna region and the wear part of the radar antenna; and
determining the wear of the at least one wear layer of the housing.

35. The method in accordance with claim 34, further comprising the steps of:
determining a transit time of the radar waves between their exit from the wear part of the radar antenna up to the incidence on the counter surface defined by the outer side of the wear layer of the crusher head; and
defining the extent of the gap present between the at least one wear layer of the housing and the counter surface defined by the outer side of the wear layer of the crusher head based on the transit time.

36. The method in accordance with claim 35, further comprising the steps of:
putting the wear of the at least one wear layer of the housing and the extent of the gap into relation with dimensions for the at least one wear layer of the housing and the gap; and
determining a wear at the wear layer of the crusher head.
